(19) United States
(12) Patent Application Publication
(10) Pub. No.: US 2020/0158152 A1
(43) Pub. Date: May 21, 2020

(54) Magnetic Self-Locking Fastening Device with Remote Release

(71) Applicant: Jaroslav Chorny, North Vancouver, OT (CA)

(72) Inventor: Jaroslav Chorny, North Vancouver (CA)

(73) Assignee: Jaroslav Chorny, North Vancouver, OT (CA)

(21) Appl. No.: 16/610,499

(22) PCT Filed: May 25, 2018
(86) PCT No.: PCT/CA2018/050620

§ 371 Date: Nov. 2, 2019

Related U.S. Application Data
(60) Provisional application No. 62/512,164, filed on May 29, 2017.

(51) Int. Cl. F16B 12/10; A47G 1/17; F16B 21/07

(52) U.S. Cl. CPC F16B 12/10; F16B 5/0642; F16B 21/078; A47G 1/17

(57) ABSTRACT

A self-fastening device for joining two objects together. The fastening device has a main slot for receiving an anchor from a second object and at least one branching slot for accommodating a latch, which by spring, magnet or gravity force is biased to the engaged position. When the anchor is inserted into the fastening device it is locked inside securely, fastening the two objects together. When a magnet strong enough to overcome the biasing force is brought from outside of the object into the vicinity of the latch, it moves the latch away from the engaged position, thereby unlocking the anchor and unfastening the objects.

### TECHNICAL FIELD

[The present invention is directed to the technical field of fastening devices, and particularly, to the technical field of fastening devices that can be disengaged remotely with the aid of magnet.

### BACKGROUND ART

U.S. Pat. No. 7,172,223 to Storvick et al. discloses a latching system for removably securing a first structure to a second structure. The system includes at least one magnetically permeable latch bar pivotally coupled to the first structure, and a biasing spring that pivots the latch bar to a latched position within a recess in the second structure, thereby securing the first structure to the second structure. Additionally, the system includes an unlatching tool that includes an embedded magnetized bar that generates a magnetic field around the unlatching tool. The unlatching tool can be used to pivot the latch bar to an unlatched position by placing the unlatching tool in close proximity to the latch bar such that the magnetic field exerts a rotational force on the latch bar, thereby pivoting the latch bar to the unlatched position.

United States Patent Application Publication No. 2009/0109575 to William et al. discloses a magnetic latch assembly which may be attached to a cabinet door. The latch assembly comprises a latch which includes a small permanent magnet. The latch is biased to a latching position by an elastic band. To unlock the cabinet door, a magnetic key is provided in the vicinity of the small magnet. The magnetic key attracts small magnet, which rotatably pivots the latch clockwise until an abutment member is withdrawn away from contact with cabinet edge.

United States Patent Application Publication No. 2014/0096467 to Norton discloses a magnetic-lock panel mounting assembly comprising a housing and a locking pin which is inserted into the housing. In a locked position, a plurality of locking elements is wedged between a groove in the locking pin and a locking sleeve to prevent the locking pin from being removed from the housing. To unlock the mounting assembly, a magnet is placed proximate a portion of the panel opposite to the mounting assembly. The magnet attracts a magnetically attractable element positioned within the mounting assembly, which causes the locking sleeve to move towards the magnet and away from the locking pin. This in turn causes the locking elements to move radially outwardly of the groove, thereby unlocking the locking pin from the housing and unfastening panels.

United States Patent Application Publication No. 2016/0032952 to McBroom et al. discloses a magnetically actuated fastener suitable for use within an electronic device housing having a first housing component and a second housing component. The magnetically actuated fastener can be attached to the first housing component and includes a spring-loaded magnetically attractable plunger that can be moved longitudinally within a fastener body from an engaged state to a disengaged state by applying a magnetic field through an outer wall of the first housing component. When the magnetically attractable plunger is in the engaged state, the plunger causes locking members to extend radially out of the fastener body to engage a channel defined by the second housing component.

United States Patent Application Publication No. 2007/0212166 to Rudduck discloses connecting means adapted to releasably fix or release a first element and a second element. The locking means may be a locking pin which lies in a recess of housing attached to the second element. When a magnetic force is applied to the locking pin, the locking pin moves within the recess, so that a leg of the locking pin is pushed into a narrow recess, in turn expanding wall so that it locks into the recess provided in the second element.

All of these earlier patented devices have many moving parts and are inconveniently bulky, unnecessarily complicated and expensive in production and therefore not affordable for big projects. The high price is the main reason why still nobody is using those devices in paneling, particularly when a plurality of fastening devices in one installation is required.

### SUMMARY OF INVENTION

The present invention relates to fastening devices. More particularly, the present invention relates to fastening devices that require inconspicuous, non-permanent, secure fixture and later when desired can be remotely disengaged with the aid of a magnet. This type of fastening devices can be used in a wide range of applications such as building paneling, cabinetry, child safety locks, automotive, decorative elements or other fixtures.

A self-fastening device for joining two objects together consists of a fastener body in a first object having a main socket for receiving an incoming anchor of a second object, and at least one branching socket positioned at an acute angle relative to the main socket for housing a latch. Magnetic attraction, gravity or a spring biases the latch to an engaged position.

As the anchor is inserted into the main socket, the latch automatically locks it inside, securely fastening the two objects together.

The fastening device can be remotely unlocked by using another, stronger permanent magnet. When the stronger magnet is applied to the outside of the first object in the vicinity of the socket with the latch, the stronger magnet pulls the latch within the socket. The latch clears the main socket and releases the anchor, allowing the two objects to be separated.

The latch is the only moving part in whole device. Therefore, the device is compact, reliable and inexpensive in production.

Disclosed herein is a fastener for joining two objects, comprising: a body defining a first socket and a second socket, wherein the body is configured to mount in a first object and the first socket is configured to receive an anchor connected to a second object; and a magnetic latch mounted in the second socket and biased by an engaging force towards an engaged position in which the magnetic latch partially blocks the first socket. The magnetic latch slides in the second socket between a disengaged position and the engaged position; when the magnetic latch is in the engaged position, it prevents the anchor from being removed from the first socket; when the magnetic latch is in the disengaged position, the anchor can be moved out of the first socket; and the magnetic latch is remotely moved from the engaged position into the disengaged position by attraction towards a magnet external to the fastener that overcomes the engaging force.

Further disclosed herein is a fastener for joining two objects, comprising: a first object defining a first socket and a second socket, wherein the first socket is configured to receive an anchor connected to a second object; and a magnetic latch mounted in the second socket and biased by an engaging force towards an engaged position in which the magnetic latch partially blocks the first socket. The magnetic latch slides in the second socket between a disengaged position and the engaged position; when the magnetic latch is in the engaged position, it prevents the anchor from being removed from the first socket; when the magnetic latch is in the disengaged position, the anchor can be moved out of the first socket; and the magnetic latch is remotely moved from the engaged position into the disengaged position by attraction towards a magnet external to the fastener that overcomes the engaging force.

### BRIEF DESCRIPTION OF DRAWINGS

The invention will be more fully illustrated by the following detailed description of non-limiting specific embodiments in conjunction with the accompanying drawing figures. In the figures, similar elements and/or features may have the same reference label.

FIG.1 is a perspective view of a fastening device used for joining two panels together in accordance with a first embodiment of the present invention, in its disengaged state.

FIG.2 is a cross-sectional side view of the fastening device of FIG. 1 in accordance with the first embodiment of the present invention, in its disengaged state.

FIG.3 is a cross-sectional side view of the fastening device of FIG. 1 in accordance with the first embodiment of the present invention, showing a process of engaging.

FIG.4 is a cross-sectional side view of the fastening device of FIG. 1 in accordance with the first embodiment of the present invention, showing two panels joined together.

FIG.5 is a cross-sectional side view of the fastening device of FIG. 1 in accordance with the first embodiment of the present invention, being unlocked.

FIG.6 is a perspective view of a fastening device in accordance with a second embodiment of the present invention, in its disengaged state.

FIG.7 is a cross-sectional side view of the fastening device of FIG. 6 in accordance with the second embodiment of the present invention, in its disengaged state.

FIG.8 is a cross-sectional side view of the fastening device of FIG. 6 in accordance with the second embodiment of the present invention, showing the process of engaging.

FIG.9 is a cross-sectional side view of the fastening device of FIG. 6 in accordance with the second embodiment of the present invention, showing a cabinet wall affixed to the cabinet bottom.

FIG.10 is a cross-sectional side view of the fastening device of FIG. 6 in accordance with the second embodiment of the present invention, being unlocked.

FIG.11 is a cross-sectional side view of a fastening device in accordance with a third embodiment of the present invention, in its disengaged state.

FIG.12 is a cross-sectional side view of the fastening device of FIG. 11 in accordance with the third embodiment of the present invention, showing the process of engaging.

FIG.13 is a cross-sectional side view of the fastening device of FIG. 11 in accordance with the third embodiment of the present invention, showing a panel affixed to a structure.

FIG.14 is a cross-sectional side view of the fastening device of FIG. 11 in accordance with the third embodiment of the present invention, being unlocked.

FIG.15 is a cross-sectional side view of a fastening device in accordance with a fourth embodiment of the present invention, in its disengaged state.

FIG.16 is an exploded view of the fastening device of FIG. 15 in accordance with the fourth embodiment of the present invention.

FIG.17 is a cross-sectional side view of the fastening device of FIG. 15 in accordance with the fourth embodiment of the present invention, showing a panel affixed to a structure.

FIG.18 is a cross-sectional side view of the fastening device of FIG. 15 in accordance with the fourth embodiment of the present invention, being unlocked.

FIG.19 is a cross-sectional side view of a fastening device in accordance with a fifth embodiment of the present invention, showing a panel affixed to a structure.

FIG.20 is a cross-sectional side view of a fastening device of FIG. 19 in accordance with the fifth embodiment of the present invention, in its disengaged state.

FIG.21 is a cross-sectional side view of a fastening device in accordance with a sixth embodiment of the present invention, showing a panel affixed to a structure.

FIG.22 is a cross-sectional side view of a fastening device in accordance with a seventh embodiment of the present invention, showing a panel affixed to a structure.

FIG.23 is an exploded view of the fastening device of FIG. 22 in accordance with the seventh embodiment of the present invention.

FIG.24 is a cross-sectional side view of anchor variations.

FIG.25 is a side view of panel affixed to a ceiling structure.

FIG.26 is a side view of two panels joined together.

FIG.27 is a side view of a cabinet wall affixed to a cabinet bottom.

FIG.28 is a side view of a cabinet wall affixed to a cabinet bottom.

### DESCRIPTION OF EMBODIMENTS

Throughout the following description, specific details are set forth in order to provide a more thorough understanding of the invention. However, the invention may be practiced without these particulars. In other instances, well known elements have not been shown or described in detail to avoid unnecessarily obscuring the invention. Accordingly, the specification and drawings are to be regarded in an illustrative, rather than a restrictive, sense. The drawings are not necessarily to scale, and the proportions of the certain parts have been exaggerated to clarify operational aspects of the invention.

The fastening device of the present invention is intended for use in combination with building panels, cabinet doors, closure panels or other fixtures that require inconspicuous, non-permanent affixation.

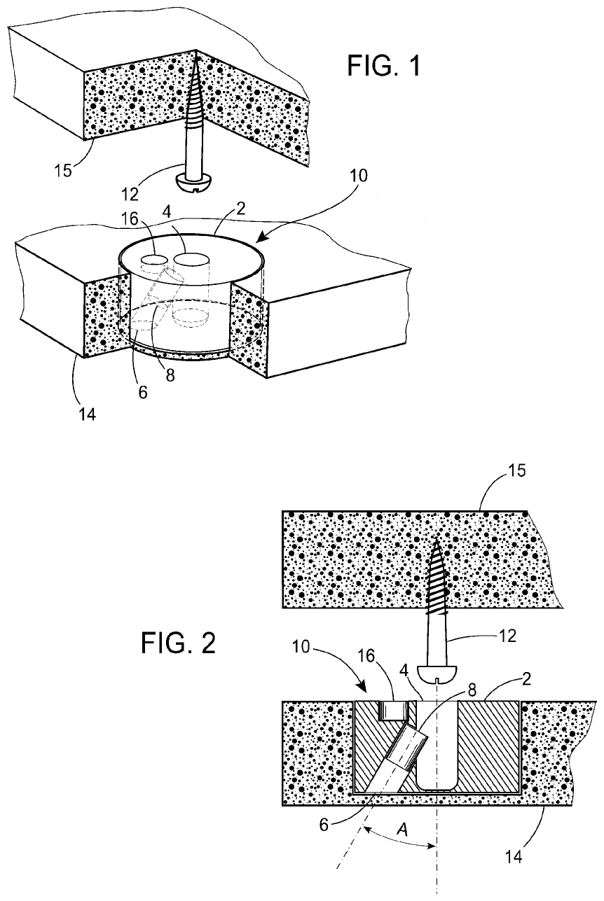

With reference first to FIG.1 and FIG.2, there is shown a fastening device 10 according to a first embodiment of the present invention, in its initial configuration with a first panel 14 and a second panel 15 in disengaged position.

Referring now to FIG.1-5, there is shown the fastening device 10 according to a first embodiment of the teachings fitted in the first panel 14.

Fastening device 10 consists of a fastener body 2 manufactured out of plastic, aluminum, brass or other non-magnetic, rigid material and in this embodiment has a cylindrical shape that can be fitted into the hole that is pre-drilled for widely popular European hinges.

Fastener body 2 features a main socket 4, a socket 6 and a small, permanent magnet 16.

Referring to FIG.2, the socket 6 is branching from the main socket 4 at an acute angle A.

Main socket 4 is intended to receive an anchor 12 of a second panel 15.

The socket 6 accommodates a latch 8 made of a magnetic material (e.g. ferromagnetic metal) which is attracted to the permanent magnet 16, and accordingly biases to engaged position.

The anchor 12 is made out of stainless steel, aluminum, brass, plastic or other non-magnetic, rigid material.

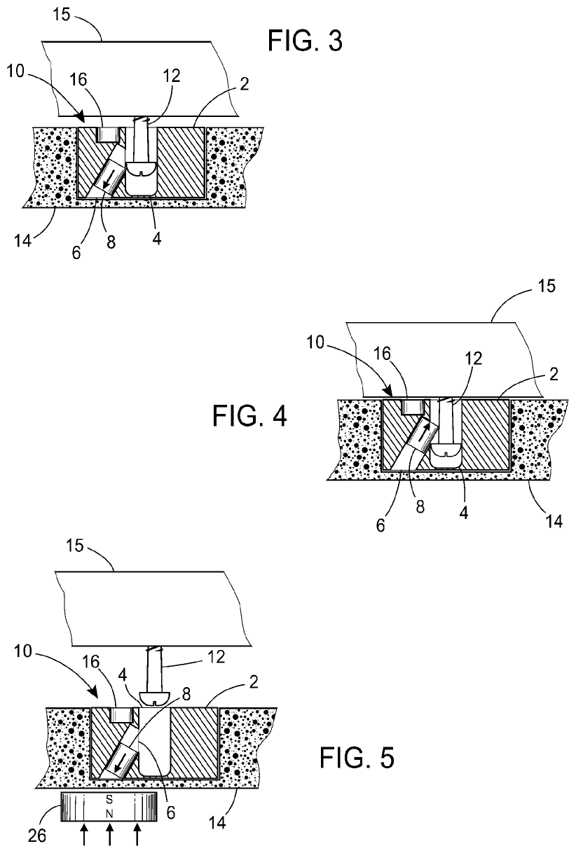

Referring now to FIG.3, as the anchor 12 enters into the main socket 4, the latch 8 is repulsed inside the socket 6 and away from the magnet 16. Due to the acute angle of the socket 6 relative to the main socket 4, the latch 8 can be moved away by the entering anchor 12 in one direction only.

Referring now to FIG.4, when the anchor 12 is fully inserted into the main socket 4, the latch 8 is released and returns to the engaged position as it is attracted by the magnet 16. In the engaged position, the latch 8 partially blocks the exit of the main socket 4 and prevents the removal of the anchor 12, thereby securely fastening the two panels 14 and 15 together.

Referring now to FIG.5, the fastening device 10 can be unlocked remotely by using another, stronger permanent magnet 26. When the magnet 26 is applied to the outside of the panel 14 in the vicinity of the socket 6, the stronger magnet 26 overpowers the force of the weaker magnet 16 and pulls the latch 8 inside the socket 6. This clears the main socket 4, releases the anchor 12 and unfasten panels 14 and 15.

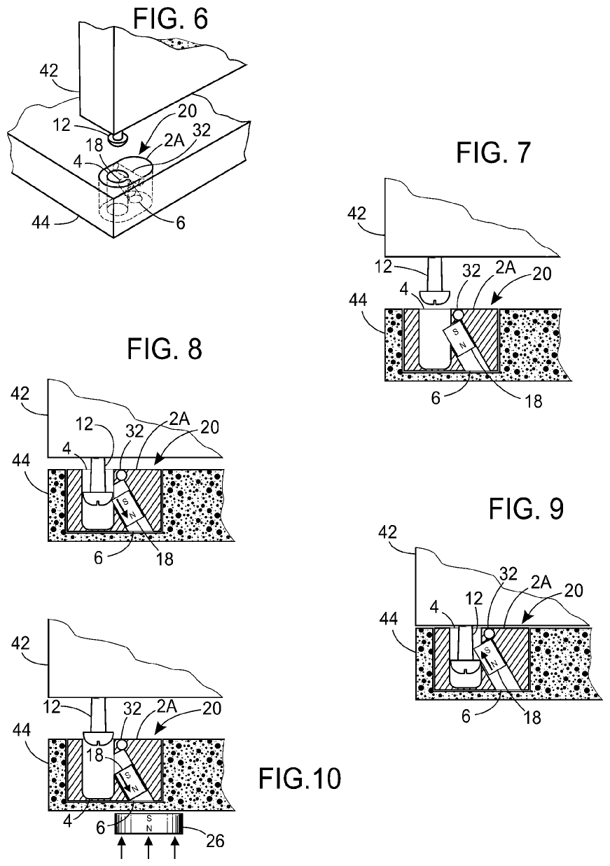

Referring now to FIG.6-10, there is shown a fastening device 20 according to a second embodiment of the teachings incorporated in a cabinet bottom 44 designed to be joined with a cabinet wall 42.

Referring to FIG.6 and FIG.7, there is shown the fastening device 20 in its initial configuration with a latch 18 in the engaged position.

Fastening device 20 consists of a fastener body 2A manufactured out of plastic, aluminum, brass or other non-magnetic, rigid material. In the second embodiment the fastener body 2A has an oval shape that is more favorable in this instance when a footprint of the body 2A has to be narrower to be covered by the thin cabinet wall 42.

Fastener body 2A consists of the main sockets 4, the branching socket 6 and a pin 32 made of magnetic material (e.g. ferromagnetic metal).

Referring still to FIG.6-10, contrary to the fastening device 10 of the first embodiment, the socket 6 of the fastening device 20 accommodates a latch 18 made of a permanent magnet. The latch 18 is attracted to the pin 32, and accordingly biases to the engaged position.

Main socket 4 is intended to receive the anchor 12 of the cabinet wall 42.

Referring now to FIG.8, as the anchor 12 enters into the main socket 4, the latch 18 is repulsed inside the socket 6 and away from the pin 32. Due to the acute angle of the socket 6 relative to the main socket 4, the latch 18 can be moved away by the entering anchor 12 in one direction only.

Referring now to FIG.9, when the anchor 12 is fully inserted into the main socket 4, the latch 18 is released and returns to the engaged position attracted by the pin 32. In the engaged position, the latch 18 partially blocks the exit of the main socket 4 and prevents the removal of the anchor 12, thereby securely fastening cabinet wall 42 to the cabinet bottom 44.

Referring now to FIG.10, the fastening device 20 can be unlocked remotely by using another, stronger permanent magnet 26. However, in this embodiment it is critical for the polarity direction of the unlocking magnet 26 to match the polarity direction of the magnetic latch 18. In some embodiments, the polarity of the unlocking magnet 26 is marked to show the user which face to present to the cabinet wall.

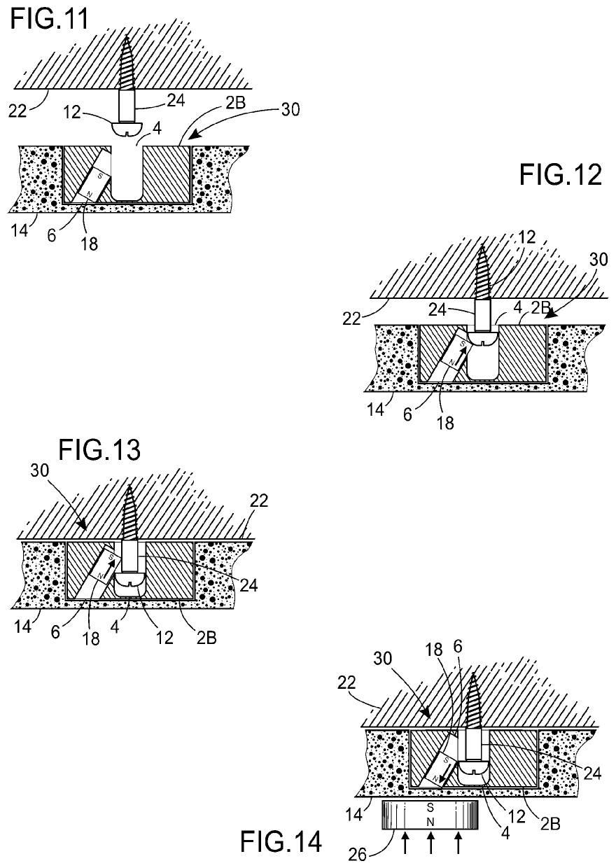

Referring now to FIG.11-14, according to a third embodiment of the teachings of the present invention, there is shown a fastening device 30 incorporated in the panel 14 designed to be affixed to the structure 22.

Fastening device 30 consists of a fastener body 2B manufactured out of plastic, aluminum, brass or other non-magnetic, rigid material.

In this distinctive embodiment, fastener body 2B consists of the main sockets 4 and the branching socket 6 only. Socket 6 accommodates the latch 18 made of a permanent magnet.

Referring still to FIG.11-14, there is shown the anchor 12 affixed to the structure 22.

The anchor 12, according to the third embodiment is made of non-magnetic material with a fitting 24 made of a magnetic material (e.g. ferromagnetic metal) intended to attract the magnetic latch 18. The fitting is a sleeve that, in some embodiments, is dimensioned so that the anchor 12, when fully tightened, is inserted to the correct depth into the structure 22. The correct depth provides that the fastener attaches the panel to the structure 22 with the minimum of slack.

Referring to FIG.11, the fastening device 30 according to a third embodiment of the teachings, is shown in its initial configuration with the latch 18 in the disengaged position resting inside the socket 6.

Referring now to FIG.12, as the anchor 12 moves to the vicinity of an entrance of the main socket 4, the metal fitting 24 attracts magnetic latch 18 and accordingly biases it to engaged position.

Referring further to FIG.12, as the anchor 12 advances further into the main socket 4, the latch 18 is repulsed inside the socket 6. Due to the acute angle of the socket 6 relative to the main socket 4, the latch 18 can be moved away by the entering anchor 12 in one direction only.

Referring now to FIG.13, when the anchor 12 is fully inserted into the main socket 4, the latch 18 is released and returns to the engaged position attracted to the metal fitting 24. In the engaged position, the latch 18 partially blocks the exit of the main socket 4 and prevents the removal of the anchor 12, thereby securely fastening panel 14 to the structure 22.

Referring now to FIG.14, the fastening device is unlocked remotely by using another, stronger permanent magnet 26. However, in this embodiment it is critical for the polarity direction of the unlocking magnet 26 to match the polarity direction of the magnetic latch 18. When the magnet 26 is applied to the outside of the panel 14 in the vicinity of the socket 6, the stronger magnet 26 overpowers the attraction of the latch 18 to the fitting 24 and pulls the latch 18 inside the socket 6. This clears the latch 18 from the main socket 4 and releases the anchor 12, detaching panel 14 from the structure 22.

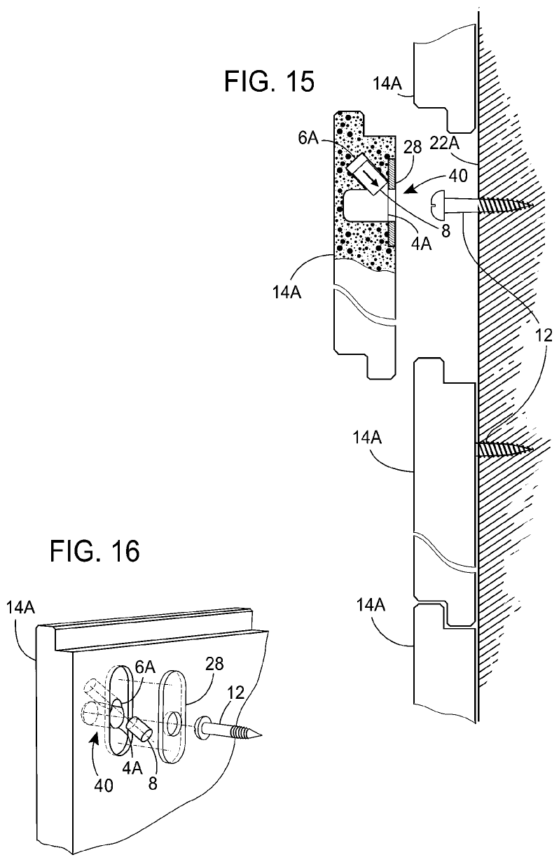

Referring now to FIG.15-18, according to a fourth embodiment of the teachings of the present invention, there is shown a fastening device 40 integrated in the panel 14A designed to be joined with a structure 22A.

Referring still to FIG.15-18, the panel 14A is made of a rigid, non-magnetic material, therefore a main socket 4A and a branching socket 6A are pre-drilled directly into the body of the panel 14A. It eliminates a necessity to manufacture the body of the fastening device as a separate part and cuts the cost of the device. The body of the panel is therefore the body of the fastener.

Referring further to FIG.15-18, there is shown the latch 8 and a cover 28. The cover 28 is intended to restrain the movement of the latch 8. The latch 8 in fourth embodiment is biased to the engaged position by the force of the gravity therefore it is critical for direction of the socket 6A always to be inclined down. The panel is, in some embodiments, marked with the orientation in which it is to be used.

As the anchor 12 enters into the main socket 4A, the latch 8 is repulsed inside the socket 6A. Due to the acute angle of the socket 6A relative to the main socket 4A, the latch 8 can be moved away by the entering anchor 12 in one direction only.

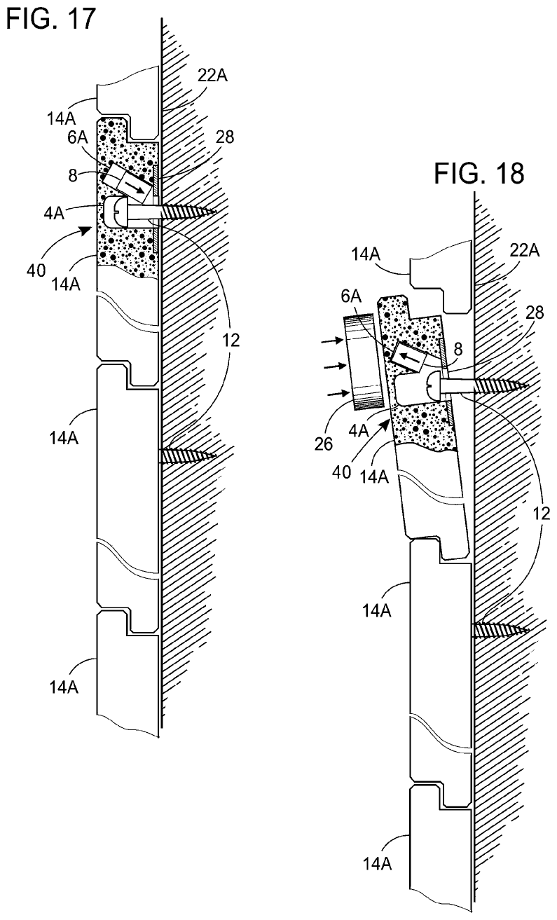

Referring now to FIG.17, when the anchor 12 is fully inserted into the main socket 4A, the latch 8 is released and returns to the engaged position due to the force of gravity. The latch 8 partially blocks the exit of the main socket 4A and prevents the removal of the anchor 12, thereby securely fastening panel 14A to the structure 22A.

Referring now to FIG.18, the fastening device 40 is unlocked remotely by using strong permanent magnet 26. When the magnet 26 is applied to the outside of the panel 14A in the vicinity of the socket 6A, the magnet 26 pulls the latch 8 inside the socket 6A. This clears main socket 4A and releases the anchor 12 detaching panel 14A from the structure 22A.

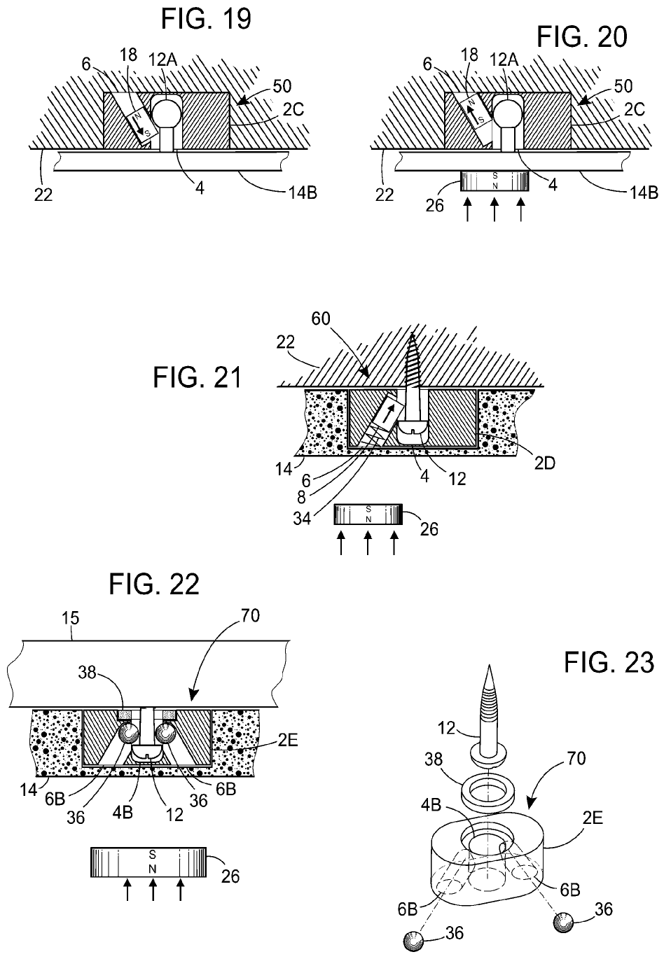

With reference now to FIG.19-20, according to a fifth embodiment of the teachings of the invention, there is shown a fastening device 50 contrary to other embodiments incorporated in a structure 22B while an anchor 12A attached to a panel 14B.

With reference still to FIG. 19-20, the fastening device 50 consists of a fastener body 2C manufactured out of plastic, aluminum, brass or other non-magnetic, rigid material.

The fastener body 2C consists of the main sockets 4 and the branching socket 6. Socket 6 accommodates the latch 18 made of a permanent magnet.

Referring now to FIG.19, there is shown the fastening device 50 in its initial configuration with the latch 18 in an engaged position and panel 14B affixed to the structure 22B. The latch 18 in fifth embodiment is biased to the engaged position by the force of the gravity, therefore it is critical for direction of the socket 6A always to be inclined down.

The locking process of the fastening device 50 of the fifth embodiment is identical to the locking process of previous embodiments.

Referring now to FIG.20, the fastening device is unlocked remotely by using another, stronger permanent magnet 26. However, in this embodiment to disengage the fastening device 50, the permanent magnet 26 has to repulse the latch 18. Therefor it is critical for the polarity direction of the unlocking magnet 26 to be opposite to the polarity direction of the magnetic latch 18.

With reference now to FIG.21, according to a sixth embodiment of the teachings of the invention, there is shown a fastening device 60 fitted in the panel 14 in its initial configuration with the latch 8 in an engaged position and the panel 14 affixed to the structure 22.

Fastening device 60 consists of a fastener body 2D manufactured out of plastic, aluminum, brass or other non-magnetic, rigid material.

Fastener body 2D consist of the main socket 4 and the branching socket 6.

Main socket 4 is intended to receive the anchor 12 of the structure 22.

Socket 6 accommodates the latch 8 and a spring 34 which accordingly biases the latch 8 to the engaged position.

The locking/unlocking process of the fastening device 60 of the sixth embodiment is identical to locking/unlocking of previous embodiments.

With reference now to FIG.22 and FIG.23, there is shown a fastening device 70 according to a seventh embodiment of the teachings of the present invention.

Fastening device 70 consists of a fastener body 2E manufactured out of plastic, aluminum, brass or other non-magnetic, rigid material.

Fastener body 2E features the main socket 4 and contrary to other embodiments has two branching sockets 6B and a magnetic ring 38.

Main socket 4 is intended to receive the anchor 12 from the second panel 15.

Two sockets 6B accommodate two spherical latches 36 made of magnetic material (e.g. ferromagnetic metal) which are attracted to the permanent magnetic ring 38 and are accordingly biased to engaged position.

The locking/unlocking process of the fastening device 70 of the seventh embodiment is identical to locking/unlocking of previous embodiments.

While above description contains many specificities, these should not be construed as limitations on the scope, but rather as an exemplification of several embodiments thereof. Many other variations are possible. For example:

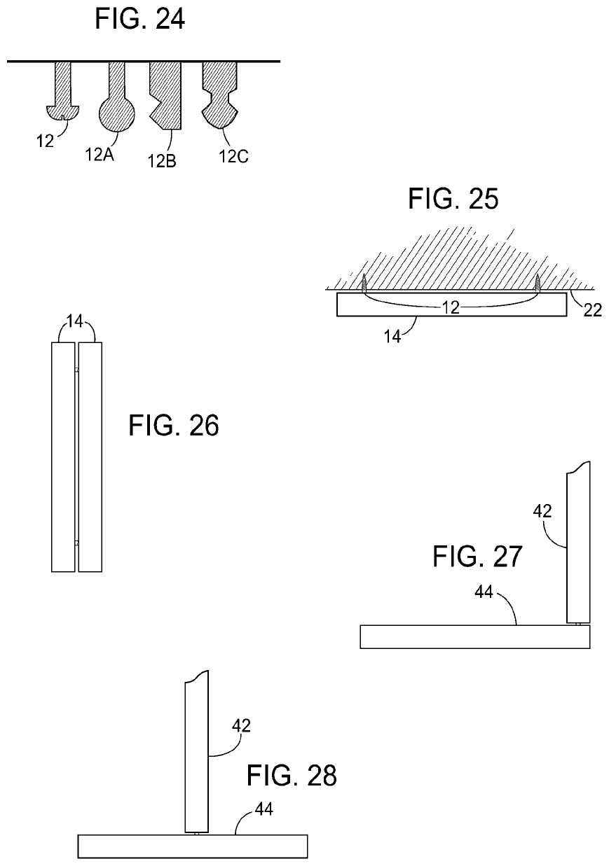

As illustrated in FIG. 24, the anchor could be of various shapes, but it requires diameter of the stem to be smaller than diameter of the head, or to have a notch in the stem at least on a side facing the latch.

The use of common screw for anchor 12 as shown in previous embodiments may be advantageous because it permits easy high adjustment and is widely available thereby eliminates the necessity to produce additional parts, cutting cost of device.

As shown in FIG. 25-28, the present invention can be practiced many different ways. Panels can be affixed horizontally or vertically as for ceilings or walls. Panels can be joined together like in FIG.26 or can be used for cabinet assembly for perpendicular affix—FIG. 27 and FIG. 28.

Features of fastening device of present invention can have many variations.

Fastener body 2 can be different shapes—cylindrical, oval, rectangular, . . . , and can feature one or more sockets 6 branching around the main socket 4.

Main socket, branching socket and latch can be different cross-sectional shapes.

Design of the present invention has only one movable part, is very compact, efficient, reliable and inexpensive in manufacturing.

### REFERENCE SIGNS LIST

2—fastener body of the first embodiment

2A—fastener body of the second embodiment

2B—fastener body of the third embodiment

2C—fastener body of the fifth embodiment

2D—fastener body of the sixth embodiment

2E—fastener body of the seventh embodiment

4—main socket

4A—main socket of the fourth embodiment

6—branching socket

6A—branching socket of the fourth embodiment

8—latch (made of ferromagnetic metal)

10—fastening device (first embodiment)

12—anchor

12A—anchor (alternative shape)

12B—anchor (alternative shape)

12C—anchor (alternative shape)

14—panel

14A—panel of the fourth embodiment

14B—panel of the fifth embodiment

15—panel of the second object

16—small magnet

18—magnetic latch (latch made of permanent magnet)

20—fastening device (second embodiment)

22—structure

22A—structure vertical

22B—structure of the fifth embodiment

24—fitting (sleeve made of ferromagnetic metal)

26—strong magnet (unlocking key)

28—cover

30—fastening device (third embodiment)

32—pin (made of ferromagnetic metal)

34—spring

36—spherical latch

38—magnetic ring (ring made of permanent magnet)

40—fastening device (forth embodiment)

42—cabinet wall

44—cabinet bottom

50—fastening device (fifth embodiment)

60—fastening device (sixth embodiment)

70—fastening device (seventh embodiment)

### CITATION LIST

Citation List follows:

### Patent Literature

PTL1: Patent WO 2017/208042 A1
PTL2: U.S. Pat. No. 9,551,165 B2
PTL3: U.S. Pat. No. 9,297,169 B2
PTL4: U.S. Pat. No. 8,434,201 B2
PTL5: U.S. Pat. No. 7,172,223 B2
PTL6: U.S. Pat. No. 5,600,977
PTL7: U.S. Pat. No. 5,485,733
PTL8: U.S. Pat. No. 5,076,623
PTL9: U.S. Pat. No. 4,919,464
PTL10: U.S. Pat. No. 3,837,525
PTL11: U.S. Pat. No. 3,744,833
PTL12: U.S. Pat. No. 3,566,636
PTL13: U.S. Pat. No. 2,809,062
PTL14: Patent US 2016/0032952 A1
PTL14: Patent US 2014/0096467 A1
PTL14: Patent US 2014/0091686 A1
PTL14: Patent US 2012/0131967 A1
PTL14: Patent US 2009/0109575 A1
PTL14: Patent US 2007/0212166 A1
PTL14: Patent US 2007/0134061 A1

1. A fastener for joining two objects, comprising: a body defining a main socket and branching socket, positioned on centerlines having an acute angle therebetween; and
a magnetic latch mounted In the branching socket, wherein the magnetic latch slides In the branching socket between a disengaged position and an engaged position;
wherein the body is configured to mount in a first object and the main socket of said body Is configured to receive an anchor connected to a second object;
wherein the magnetic latch is biased by an engaging force towards an engaged position in which the magnetic latch partially blocks the main socket;
wherein, when the magnetic latch is in the engaged position, it can be repulsed by the anchor entering the main socket;
wherein, when the magnetic latch Is In the engaged position, it prevents the anchor from being removed from the main socket;
wherein the magnetic latch is moved from the engaged position into the disengaged position by a force of a magnet external to the fastener that overcomes the engaging force;
wherein, when the magnetic latch is in the disengaged position, the anchor can be moved out of the main socket;

2. The fastener of claim 1, wherein the magnetic latch is made from ferromagnetic material.

3. The fastener of claim 1, wherein the anchor is a cap-head screw made of non-magnetic material.

4. The fastener of claim 1, further comprising a permanent magnet mounted In the body that provides the engaging force.

5.The fastener of claim 1, wherein a gravitational force biases the latch to the engaged position.

6. The fastener of claim 1, further comprising a spring in the branching socket that provides the engaging force.

7. The fastener of claim 1, wherein the magnetic latch is a permanent magnet and a magnetic pin is mounted in the body, wherein said latch is biased to the engaged position by the magnetic pin.

8. The fastener of claim 1, wherein the magnetic latch is a permanent magnet and the anchor has a magnetic insert that causes said latch to bias to the engaged position.

9. The fastener of claim 1, wherein the body defining the main socket and one or more further branching sockets, positioned around the main socket at acute angles.

10. A fastener for joining two objects, comprising:
a first object defining a main socket and a branching socket, wherein the main socket and the branching socket positioned on centerlines having an acute angle therebetween; and
a magnetic latch mounted in the branching socket, wherein the magnetic latch slides in the second socket between a disengaged position and an engaged position;
wherein the main socket of the first object is configured to receive an anchor connected to a second object;
wherein the magnetic latch Is biased by an engaging force towards an engaged position in which the magnetic latch partially blocks the main socket;
wherein, when the magnetic latch is in the engaged position, it can be repulsed by the anchor entering the main socket;
wherein, when the magnetic latch is in the engaged position, it prevents the anchor from being removed from the main socket;
wherein the magnetic latch Is moved from the engaged position Into the disengaged position by a force of a magnet external to the fastener that overcomes the engaging force.
